(19) United States
(12) Patent Application Publication
(10) Pub. No.: US 2001/0018177 A1
(43) Pub. Date: Aug. 30, 2001

(54) INTERACTIVE METHOD OF TEACHING LANGUAGE

(76) Inventor: NANCY L. VAN DUSEN, MORENO VALLEY, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/384,941

(22) Filed: Aug. 27, 1999

Related U.S. Application Data
(60) Provisional application No. 60/098,263, filed on Aug. 28, 1998.

(51) Int. Cl. G09B 19/00

(52) U.S. Cl. 434/156

(57) ABSTRACT

A method of teaching English that is designed to be personal and interactive so as to stimulate the interest of emergent and early readers. In particular, the method comprises a sequence of steps to be performed on a daily basis wherein the steps comprise displaying to the students a written message comprising language arts instructional points. The method further comprises inducing the students to read the message silently and out loud in addition to asking each other language arts concepts related questions so as to reinforce the concepts.

### RELATED APPLICATIONS

This application claims the benefit of U.S. provisional application No. 60/098,263 which was filed on Aug. 28, 1998.

### BACKGROUND OF THE INVENTION

1. Field of the Invention

The invention relates to a method of teaching a language such as English and more particularly to an interactive and personalized method of teaching emergent or early readers to read and write English.

2. Description of the Related Art

Students typically begin developing their ability to read and write their native language in the primary schools where they are introduced to many basic language arts concepts such as proper writing mechanics and vocabulary usage. In fact, the core curriculum of most primary schools in this country includes lessons, in one form or another, designed to develop and strengthen the students' ability to read and write English. However, one difficulty of teaching language arts to primary school students is that it relies heavily on the development of the students' memory and creative faculty in addition to their visual and auditory recognition ability.

In particular, it is especially challenging to teach emergent and early readers to read and write as most early readers are young in age and therefore have shorter attention spans. In fact, early readers may lose interest in the lessons quickly if they have limited comprehension ability in both the subject matter as well as the purpose of the lessons. Furthermore, early readers tend to experience difficulty not only in learning the language arts concepts, but also in applying the concepts to future use if they have a short memory and less developed creative faculty.

To address these particular problems, various teaching methods have been developed for teaching reading and language arts concepts and skills to emergent and early readers. Most methods involve using text books to teach the students discrete language arts topics and then periodically assigning the students related exercises from work books. These exercises, however, are often viewed as busy work as they fail to emphasize to the students how to connect together each discrete language arts concept and weave them into the students' own writing. Additionally, language arts lessons that are given on a periodic basis are often forgotten by younger students with shorter memories and attention spans.

Hence, it is desirable to have a method of teaching language arts to younger students wherein the method involves daily instructions in new as well as previously taught concepts. One particular example comprises a daily instruction program called Daily Oral Language (DOL) published by McDougal, Littell & Co. wherein the students are required to edit grammatically incorrect sentences or paragraphs as part of a daily routine. Although the “DOL” program is designed to drill the students repetitively in writing mechanics, it is impersonal and non-interactive. Younger students can get bored quickly when the material serves no personal interest to them. In fact, some will tend to perceive impersonal exercises as routine and monotonous, meaningless assignments that they must do for the teacher. Consequently, the methods in teaching language arts skills to emergent and early readers are often less effective due to their comparatively impersonal and non-interactive nature.

Hence, it will be appreciated that there is a continuing need for a method of teaching reading and writing of languages, such as English, to emergent and early readers wherein the method is effective in building a strong foundation in the language arts.

### SUMMARY OF THE INVENTION

The aforementioned needs are satisfied by the present invention comprising a method of teaching reading, writing, listening, and speaking skills to emergent and early readers. In one aspect, the present invention comprises displaying a written message to the students upon their entry into the classroom every morning, wherein the written message contains at least one language arts instructional point. The students are allowed to silently read the written message for a pre-selected period of time, after which the individual students share with their teacher and classmates what they remember from the message.

Following the content based sharing session, the teacher proceeds to read the written message out loud to the class and then induces one or more selected students to do the same. Subsequently, the teacher further induces one or more selected students to formulate and ask the other students language arts related questions based on the written message. In addition to performing the above sequence of routines on a daily basis, the teacher periodically reinforces to the students the language arts concepts and instructional points that were contained in the daily written messages.

In one embodiment, the written message communicates to the students information that is pertinent to and appropriate for that particular school day. Since the message directly relates to the students, it is likely to spark their interest in analyzing and understanding its content. Unlike the impersonal reading passages that are typical of other language arts educational material, the written message of this particular embodiment is unique in that it is personal to the students and therefore piques their curiosity and interest level from the outset. Students are willing to expend more effort in analyzing and understanding a message when the subject matter directly relates to them.

Furthermore, in this embodiment, each message comprises a plurality of language arts instructional points such as the identification and use of adjectives and verbs, main ideas and supporting details within a paragraph, and proper punctuation and capitalization. Each instructional point is designed to teach a particular language arts skill or concept so that the students, in the process of analyzing the content of the personal message, are in effect learning and developing their language arts skills. The instructional points contained within the messages teach new language arts skills as well as reinforce previously learned concepts.

In this particular embodiment, the new language arts skills contained in a written message are introduced only after the students have had a chance to analyze the message so as to provide the students an opportunity to explore the new concepts independently before it is taught to them. In particular, students are likely to have a better appreciation for a new concept if they had explored it independently before learning about it from a teacher.

In another embodiment, the written message is displayed on an overhead projector at the beginning of each school day and the students are allowed approximately five minutes to silently read the message following their first entry into the classroom every morning. The display of the message at the beginning of each day can establish a positive “beginning day routine” that the students anticipate with enthusiasm, which will enhance their interest level and willingness to learn. Additionally, the teacher can use the message displayed in the early morning as a reference point for teaching reading or writing later on in the day.

Moreover, at the end of the five minute silent reading period, the teacher induces students to share what they remember about the content of the message. In one embodiment, this step takes place after all the beginning day tasks such as roll taking and recitation of Pledge of Allegiance are completed. Preferably, the teacher removes the displayed message before the students begin to recall the content of the message. The students will derive intrinsic reward from sharing with their teacher and classmates what they recall from the message, yet the teacher may also choose to provide positive reinforcements such as stickers or points for students who correctly answer questions related to the content of the message.

After the comprehension and recall session, the teacher redisplays the message and tracks each word with a device such as a meter stick while slowly and expressively reading the message to the class. In one embodiment, the simultaneous tracking and reading is also done when the students read to the class wherein one student tracks and another reads. Tracking each word while reading helps the slower readers follow along. In fact, the process of having students read and track can be repeated with a plurality of different students so that the repetitions will help emergent readers attain a firmer grasp on word recognition and pronunciation. Additionally, the students are induced to read portions of the message chorally while the teacher or one of the students tracks the message.

After reading the message silently and out loud, the students are encouraged to formulate and ask each other language arts concepts based questions related to the message. Unlike most traditional lessons wherein teachers typically ask questions while the students answer, this novel method allows the students to formulate questions so as to motivate them to apply previously taught concepts in the formulation of their questions. This exercise not only reinforces the previously learned language arts concepts but also allows the students to use their creativity in composing the questions. For example, the teacher may choose to encourage students to ask each other specific writing mechanics questions such as to identify the number of paragraphs in the written message. Additionally, the students are also constantly reminded to formulate and answer questions using complete sentences throughout this exercise. Occasional subtle hints from the teacher to the students who are formulating the questions make the entire exercise less daunting for emergent readers who are not confident in their skills.

Preferably, the sequence of steps described above is repeated daily so that the students will be developing their language arts skills on a continuous basis. In particular, daily review and reinforcement of previously learned concepts will enhance the students' familiarity with the concepts and thus their ability to apply the skills learned. Additionally, the present sequence of steps, when performed as a daily routine, makes early readers more comfortable with reading and more confident in their language arts skills.

From the foregoing, it will be appreciated that the aspects of the present invention introduce a novel method of teaching reading, writing, listening, and speaking to emergent and early readers wherein the method is personal and interactive so as to spark the interest of the students. The method comprises a daily personal written message displayed to the students, wherein the students learn to read and analyze the message. Furthermore, the students take turns formulating and asking each other language arts related questions based on the message. Additionally, the method provides a means for the teacher to teach and reinforce language arts concepts learned throughout the course of the school year. The present invention therefore not only addresses the undesirable aspects of impersonal and non-interactive language arts teaching methods, but also provides a method that stimulates the students to think in a creative way and reinforces the previously learned concepts in a positive environment. These and other objects and advantages of the present invention will become more apparent from the following description taken in conjunction with the accompanying drawings.

### BRIEF DESCRIPTION OF THE DRAWINGS

FIG. 1 is a flow chart of the illustrated embodiment of a method of teaching reading and writing a language such as English to emergent and early readers;

FIG. 2 is an illustration of one embodiment of a first step of FIG. 1 comprising a written message that is pertinent to and appropriate for that particular school day that is to be displayed to the students;

FIG. 3 is another illustration of one embodiment of a first step of FIG. 1 comprising a written message that includes material from previously learned concepts in Science which is to be displayed to the students;

FIG. 4 is another illustration of one embodiment of a first step of FIG. 1 comprising a written message that is lengthier, more complex and includes opportunities for the teacher to model editing of a text;

FIG. 5 is another illustration of one embodiment of a first step of FIG. 1 comprising a written message that is lengthier, more complex, and includes “difficult words” that are identified by the students and are underlined; and

FIG. 6 is another illustration of one embodiment of a first step of FIG. 1 comprising a written message that is lengthier, more complex, and includes adjectives that have been discussed and highlighted.

### DETAILED DESCRIPTION OF THE PREFERRED EMBODIMENT

Reference will now be made to the drawings wherein like numerals refer to like parts throughout. As will be described hereinbelow, the preferred embodiment provides a method of teaching language arts skills and concepts wherein the method is adapted to be in context, personal, and interactive so that emergent and early readers will benefit.

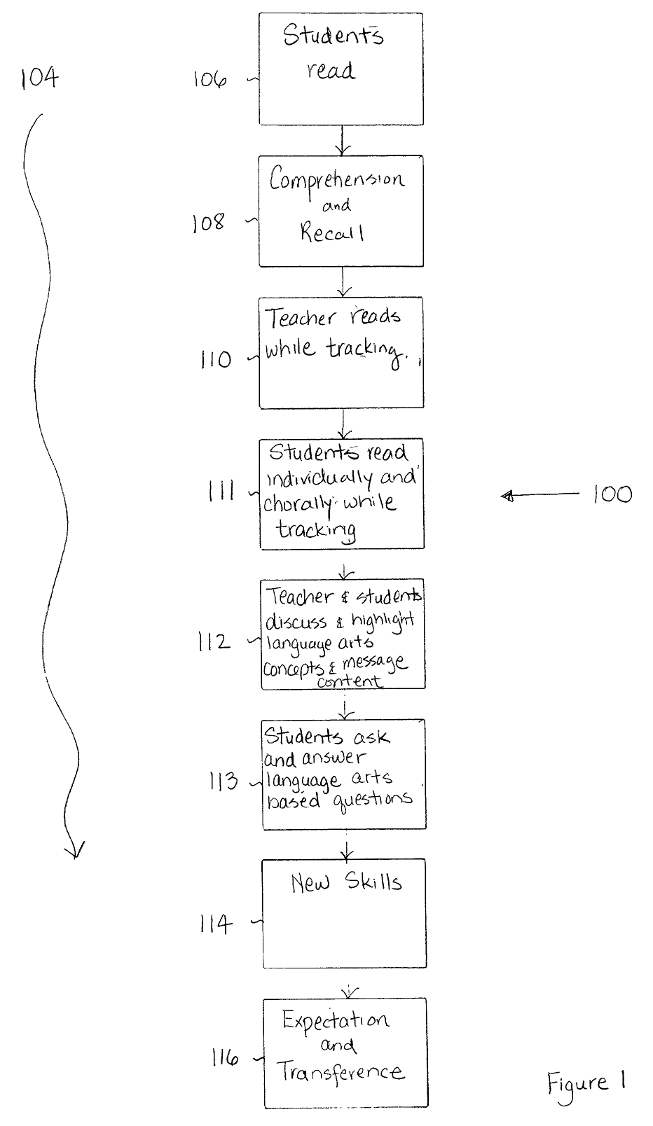

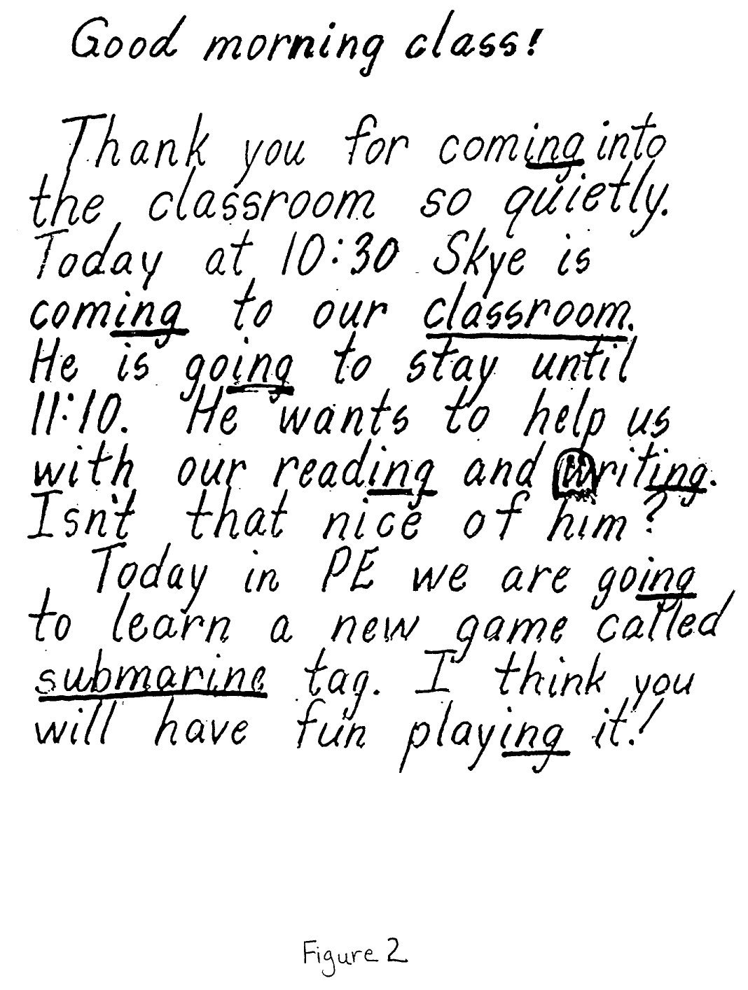

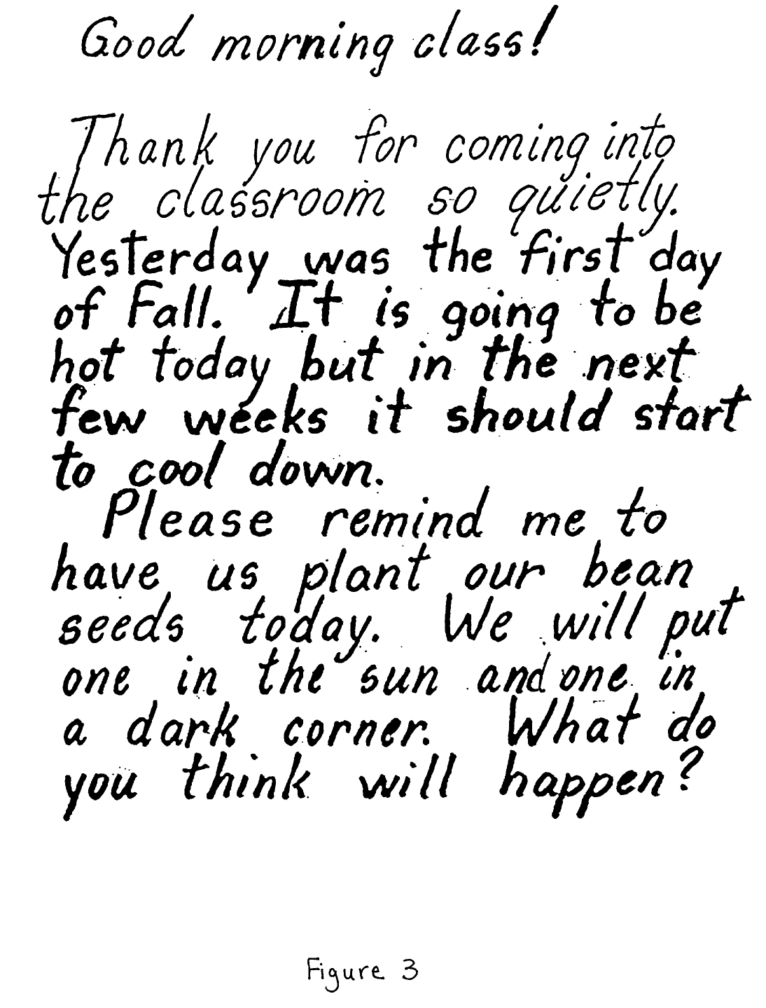

FIG. 1 shows an illustrated embodiment of a flow chart 100 for the present method wherein the flow chart 100 comprises a plurality of steps to be performed in a sequence 104. The sequence 104 comprises a first step 106 wherein the students, upon their entry into the classroom, silently read a written message such as the messages illustrated in FIGS. 2 and 3 displayed on an overhead projector. The silent reading period preferably occurs right at the start of the school day and preferably lasts approximately five minutes. The silent reading period is intended to encourage the emergent and early readers to individually read and analyze the meaning of the message independently so as to reduce their reliance on others. The silent reading period also allows the students to easily make the transition from a socializing before school environment to the more studious in-school environment. During the silent reading period, the teacher can take this time to perform any of a number of tasks that occur at the beginning of the school day including taking roll, circulating through the room to collect and discuss the previous night's homework with individual students and the like.

Preferably, the displayed message is pertinent to and appropriate for that particular school day so as to heighten the interest level and pique the curiosity of the students. For example, as shown in FIG. 2, the displayed written message typically begins with the following: “Good Morning Class. Thank you for coming into the classroom quietly.” The message can further describe events that are to take place during that particular school day. The exact subject matter of the message is of course, left to the discretion of the individual teacher. Preferably, subjects are selected so as to be of interest to the students and also to introduce language arts instructional points as will be described in greater detail below.

In fact, the content of the written message may also relate to concepts covered in other subjects areas. In one embodiment as shown in FIG. 3, the written message challenges the students to answer a question that involves recalling what they had previously learned in Science. Unlike the impersonal reading passages suggested by prior references, the written message of the illustrated embodiment is personal and specifically directed to the students in the class so as to heighten their interest and make them feel valued and informed.

Furthermore, each displayed message comprises one or more Language Arts instructional points. A Language Arts instructional point typically comprises aspects of writing mechanics such as identification and use of adjectives and verbs, main idea and supporting details within a paragraph, and proper punctuation and capitalization. In one embodiment, the displayed message comprises primarily previously taught instructional points so as to provide a review and reinforcement of skills the students already learned. Yet, in another embodiment, the message comprises one or more new Language Arts instructional points which the teacher will introduce to the class in a manner to be described in detail below.

An additional advantage of the present method is that it gives the teacher control in creating a message that is appropriate to the interest, skill and reading level of the class. In one embodiment, the teacher may choose advanced and sophisticated vocabulary to challenge the students and expand their vocabulary base. A key aspect of the program is that the teacher models syntax, writing technique, and style in the daily messages so as to provide examples that the students can follow in their own writing and speaking.

As is illustrated in FIG. 1, the sequence 104 also comprises a second step 108 wherein the teacher induces the students to share with their classmates what they remember from the content of the message. In one embodiment, after displaying the message in step 106 for a selected period of time, e.g. 5 minutes or so, the teacher removes the displayed message and induces student volunteers to share or tell what they remember from the message. Students are preferably required to communicate orally using complete sentences in their response.

Occasionally, the teacher may also induce or prompt the students to recall the message by asking content based, open ended questions related to the displayed message. The teacher has the option of prompting the students by asking content based questions during the step 108 to enhance their skills at recalling what they have read and understanding what they have read. Generally, the teacher only asks such questions when the student's recollection of the content of the message falters. Some sample content based questions for the example of FIG. 2 could include “Who is coming to our class today?”, “What is Skye going to do?” and “How long will he stay here?” Preferably, the exercise is designed so that students derive intrinsic rewards from reading and sharing what they recall with each other. However, the teacher may also choose to provide positive reinforcement through rewards such as stickers or points for those students who correctly recalls the subject matter or content of the message.

One particular advantage of having the students orally recall the content of the message is that it trains them to independently analyze a written message and communicate its content coherently, in complete sentences to an audience using their own words. Hence, the students develop not only their ability in reading comprehension but also their skills in composing thoughts into coherent, grammatically correct sentences and summarizing information.

FIG. 1 further illustrates that a third step 110 of the sequence 104 comprises the teacher redisplaying the message and reading the message with expression out loud to class. In one embodiment, the teacher turns on the overhead projector so the message is visible and, with a meter stick or pointer, slowly tracks and reads the message to class word by word. By reading the message word by word while visually tracking the words, the students can associate the written word with the spoken word. As is understood in the teaching profession, students learn to read some words phonetically and other words by sight. The exercise also allows students to learn to read using context clues in figuring out difficult or unfamiliar words. By repeating the message and tracking the words, word by word, the learning of new words can be facilitated, and the students' knowledge of previously learned words can be reinforced. Following the teacher reading and tracking the message, the teacher preferably induces the entire class to chorally read at least a portion of the message while the teacher simultaneously tracks the message.

After the teacher has read the message and after at least a portion of the message has been chorally read, a plurality of students are induced to do the same in step 111. In the illustrated embodiment, the teacher selects one student to read the message and that student chooses a classmate to track or vice versa. The step 111 is then repeated a plurality of times to allow more students opportunities to participate as well as to give the students repeated practice in reading the message and tracking a spoken message. By making the students read the message, with another student tracking the words of the message with a pointer, the exercise in sight reading words and reading out loud is made more interactive and interesting for the students. Additionally, students may also use context and phonetic clues to figure out unfamiliar words in the message.

Hence, these steps effectively allow the teacher to teach the students proper pronunciation and word recognition so as to develop the students' visual and auditory skills related to language arts. Additionally, tracking of the words while repeatedly reading over the message help emergent or early readers follow along and obtain a firmer grasp on word recognition and pronunciation.

Following the students reading the message several times, the teacher can then instruct and discuss with the students language arts related instructional points and/or the content of the message in step 112. In particular, various language arts instructional points and concepts can be included in the message. These language arts instructional points can include such things as new words, new punctuation, grammar rules and other written language rules.

In this way, language arts instructional points can be introduced to the students in their actual usage context. This allows for explanation of the language arts instructional point through the use of an example contained in a message that the students are familiar with as a result of steps 106 and 108. Moreover, the teacher may at this time also discuss content based concepts with the students. For example, a science or social studies concept referred to in the message may be explained by the teacher.

As indicated in FIG. 1, the teacher can then induce selected students to ask additional language arts instructional points based questions of their fellow students in step 113. Again, this allows the students to interactively teach each other language arts instructional points or reinforce previously learned language arts instructional points. By selecting students to ask the questions, the student is forced to identify a language arts instructional point, such as a grammar rule, a vocabulary word etc. and then formulate a question about the particular word. With respect to the example shown in FIG. 2, the language arts instructional points based questions that the students ask can include questions about why is the S in Skye (line 3) capitalized? (answer: Skye is capitalized because it is the name of a person) etc.

In the process of formulating their own questions, the students are encouraged to apply previously learned Language Arts skills, particularly those covered in the instructional points of past messages. Preferably, the teacher guides and directs this question and answer session, giving students verbal praise and reinforcement, as well as reminders to answer questions using complete sentences. This unique step enables the students to apply the skills they have learned in a creative manner as they formulate language arts related questions for their classmates. In one sense, formulation of questions requires the students to apply not only previously learned skills but also use their creative faculty. Furthermore, the students are typically willing to exert more effort into an exercise wherein they perceive themselves as performing the role of a teacher in asking their classmates questions.

As is also indicated in FIG. 2, the teacher can also highlight some of the words that are the subject of the language arts instructional points for added emphasis. In this case, each of the words ending in -ing have been highlighted to demonstrate the similarity of endings of each of these words to the students. Preferably, the highlighting of the words indicative of the language arts instructional point occur following the initial display of the message.

In another embodiment, at anytime during the lesson, the teacher may choose to ask a question that leads into a short directed lesson introducing a new language arts concept, skill, or alternatively a concept based lesson. As FIG. 1 shows, step 114 may follow the question and answer session wherein the teacher introduces a new instructional point that is used in the message. The concepts learned in every message are periodically reinforced with the students.

Preferably, the sequence 104 of steps is performed at the beginning of each school day so it establishes a positive “beginning day routine” so that the students may anticipate with enthusiasm. Moreover, the teacher may also use the material in the sequence of steps taught in the beginning of the day as a reference point for teaching reading or writing later on in the day. Additionally, students are expected to transfer what they learn to reading and writing activities throughout the day as shown in Step 116. Repetition of the steps on a daily basis will enhance the overall effectiveness of this particular teaching method as daily repetition of the steps is integral to a successful adaptation of the present language teaching method.

The sequence 104 of steps is preferably repeated on a daily basis wherein previously learned language arts concepts are reinforced repeatedly so that they become second nature to the students. Additionally, the sequence 104 of steps, when performed on a daily basis, makes the students more comfortable with reading and learning about language arts. Daily use of the sequence 104 of steps also establishes a routine that the students learn to anticipate with enthusiasm. Furthermore, daily use of the present teaching method fosters an environment where the students are constantly challenged to apply their language skills to activities that they perceive as interesting and fun.

By repeating this process essentially each morning of the school year, the procedure can be repeated over and over. The teacher can tailor each individual message for a particular day such that additional information can be provided to the students, e.g., that it is someone's birthday, that there is an event planned for the day. Further, various themes occurring during the school year can also be emphasized, e.g., the change of seasons, upcoming holidays etc. Preferably, the process is initiated at the beginning of the school year with relatively simple message and, as the year progresses and the students become more familiar with various language arts concepts, more complex messages containing additional instructional points can be used. Again, the entire method is preferably performed at the beginning of the school day and is completed within the first ½ hour to 1 hour of school depending upon the complexity of the message, the number of language arts instructional points contained within the message and whether the message includes a language arts instructional points that leads to a short directed lesson.

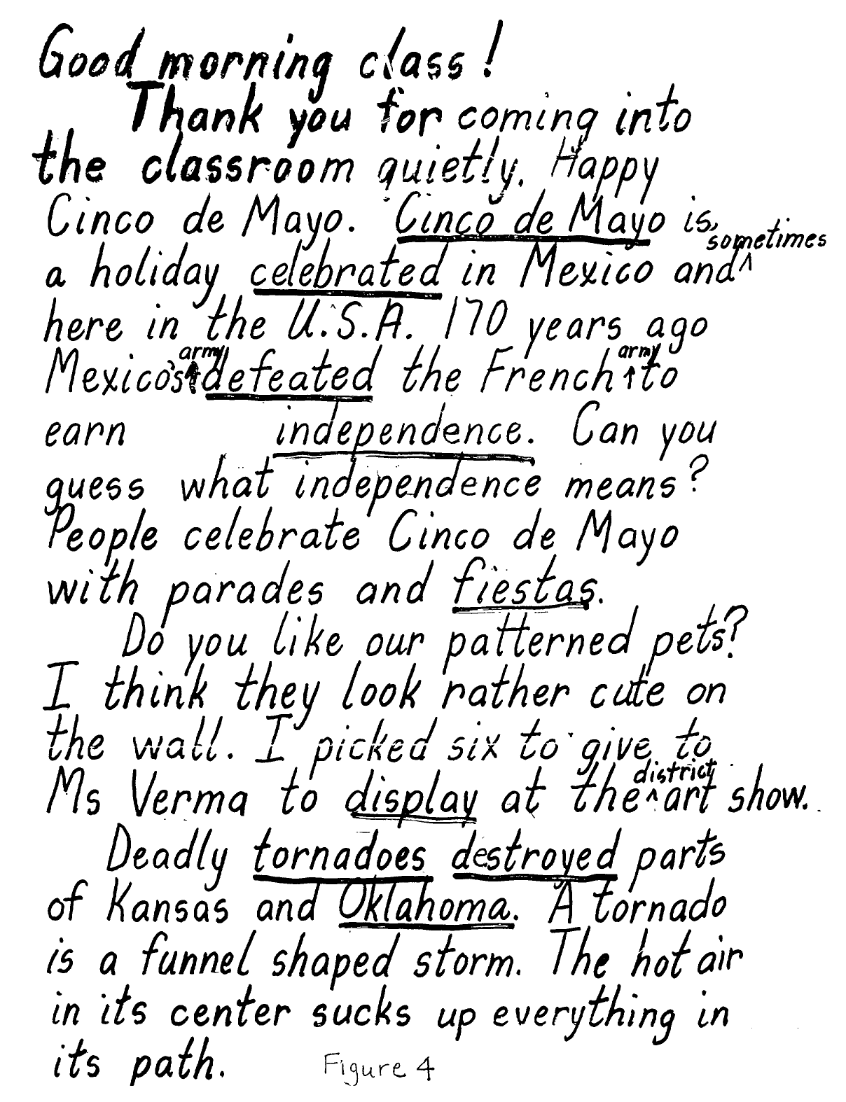

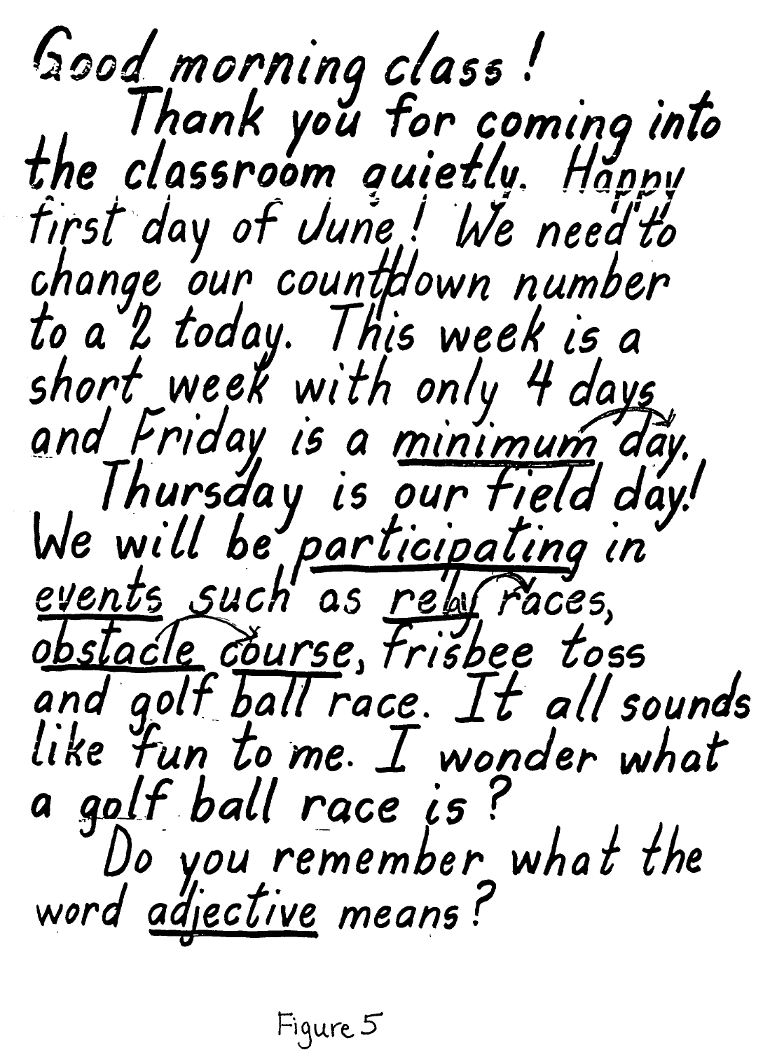

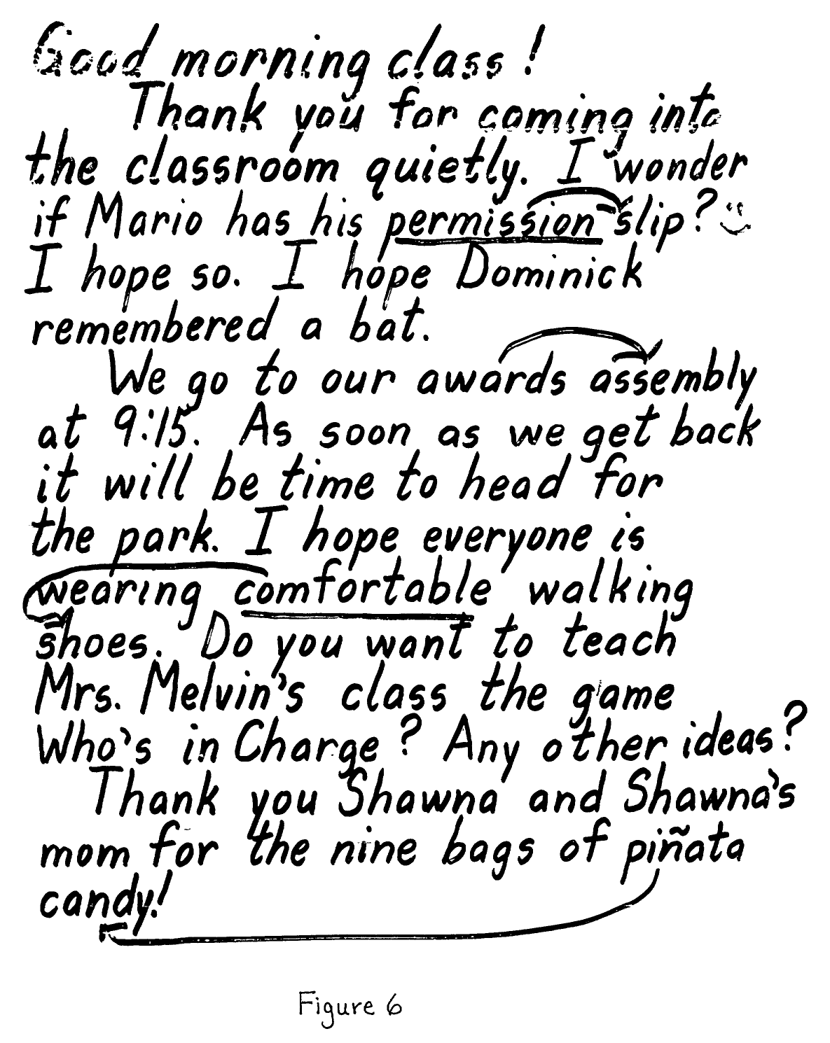

FIGS. 4, 5, and 6 illustrate messages displayed toward the end of the school year wherein the messages are substantially lengthier and include more sophisticated vocabulary and sentence structure than messages displayed near the beginning of the school year as shown in FIGS. 2 and 3. The daily messages can be photocopied and assembled into books on a periodic basis, e.g. monthly. These books can then be used as a reference for the students to provide examples of previously learned language arts skills and also can be used to share with visitors or read for fun.

Hence, the disclosed embodiment provides a personal and interactive method of teaching reading and writing English to emergent or early readers wherein the method comprises an interactive routine that is designed to reinforce previously learned skills while at the same time encourage students to apply the newly taught concepts for future use. Additionally, the method provides teachers an opportunity to teach Language Arts skills or concepts in context in a unique personalized manner that sparks the interest and curiosity of the students.

This invention offers advantages of being able to provide a Language Arts teaching method that allows the students to actively participate in their learning wherein the students are constantly challenged. Additionally, the method is effective in reinforcing previously learned concepts to the students on a daily basis without seeming tedious to the students. Lastly, the method offers a positive learning environment wherein the students are challenged to think independently and creatively. While the preferred embodiment has described a method of teaching English language skills, this method can be adapted for use in teaching any of a number of different languages and concepts without departing from the spirit of the present invention.

Although the foregoing description of the preferred embodiment of the present invention has shown, described and pointed out the fundamental novel features of the invention, it will be understood that various omissions, substitutions, and changes in the form of the detail of the method as illustrated as well as the uses thereof, may be made by those skilled in the art, without departing from the spirit of the invention. Consequently, the scope of the present invention should not be limited to the foregoing discussions, but should be defined by the appended claims.

What is claimed is:

1. A method of teaching language arts skills comprising the steps of:
(1) displaying a written message on a display to students upon the students entry into the classroom, wherein the written message contains language arts instructional points;
(2) allowing the students to silently read the written message for a preselected period of time upon entering the classroom;
(3) following step (2) inducing one or more selected students to share what they remember of the content of the written message;
(4) following step (3) simultaneously displaying the written message and then reading the written message out loud by the teacher and by the students;
(5) following step (4), inducing one or more selected students to simultaneously display and read the written message out loud;
(6) following step (5), inducing one or more students to discuss the content of the message, analyze and ask other students language arts related questions based on the written message.

2. The method of claim 1, further comprising following step (6), periodically reminding the students of the grammatical and language arts concepts that were contained in the written message.

3. The method of claim 1 further comprising:
following step (5) leading a directed lesson introducing a new language arts concept or skill.

4. The method of claim 1, wherein step (5) is repeated with a plurality of different students.

5. The method of claim 4, wherein the step (6) further comprises encouraging the selected students to ask grammatical and language arts related questions of their classmate.

6. The method of claim 5, further comprising the teacher asking questions to prompt the students to recall language arts concepts to thereby induce the students to ask related language arts questions of other students.

7. The method of claim 1, wherein step (3) further comprises:
ceasing the display of the written question message prior to asking content based questions so as to provide the students with positive reinforcement for correctly reading and recalling the subject matter of the written message.

8. The method of claim 1, wherein the step (2) occurs at the beginning of the school day and continues for approximately 5 minutes.

9. The method of claim 1, wherein step (1) comprises displaying a written message on an overhead display.

10. The method of claim 1, wherein step (6) comprises asking a student to identify the number of paragraphs in the written message.

11. The method of claim 1, wherein step (4) is accomplished by reading and simultaneously tracking the displayed words using a meter stick.

12. A method of claim 1 wherein the displaying a written message step comprises teaching language arts skills comprising the steps of:
displaying the following written message on an overhead projector to students upon the students' entry into the classroom:
“Good morning class!
Thank you for coming into the classroom so quietly. Today at 10:30 a.m. Skye is coming to our classroom. He is going to stay until 11:10 a.m. He wants to help us with our reading and writing. Isn't that nice of him?
Today in PE we are going to learn a new game called submarine tag. I think you will have fun playing it!”.

13. The method of claim 1, wherein step (5) further comprises inducing the class to read chorally together at least one portion of the message.

14. The method of claim 1, wherein the written message of step (1) comprises personalized, relevant information to the students.

15. The method of claim 1, wherein the step (3) further comprises the teacher asking the students content based questions about the written message.

16. The method of claim 1, further comprising a directed lesson introducing a new language arts concepts or skills at the end of at least one of the steps.

17. The method of claim 1, further comprising asking the question:
“Who can tell me one thing they remember from the message?”.

18. The method of claim 12 wherein step (6) comprises:
one or more selected students asking the following language arts related questions based on the message;
“Why is the letter S capitalized in the word Skye?
How many paragraphs are there in today's message?
How many sentences are there in the first paragraph?”.

19. The method of claim 1, further comprising the teacher inducing the students to ask and answer all questions in complete sentences.
